(19) United States
(12) Patent Application Publication
(10) Pub. No.: US 2023/0180238 A1
(43) Pub. Date: Jun. 8, 2023

(54) TECHNIQUES FOR THERMAL MITIGATION AND OVERHEATING ASSISTANCE SIGNALING

(71) Applicant: QUALCOMM Incorporated, San Diego, CA (US)

(72) Inventors: Shanshan WANG, San Diego, CA (US); Arvind Vardarajan SANTHANAM, San Diego, CA (US); Tian MAI, San Diego, CA (US); Reza SHAHIDI, La Jolla, CA (US); Mahbod GHELICHI, San Diego, CA (US); James Francis GEEKIE, Carlsbad, CA (US); Yash PATHAK, Erie, CO (US); Sundaresan TAMBARAM KAILASAM, San Diego, CA (US)

(21) Appl. No.: 17/997,624

(22) PCT Filed: Jun. 30, 2021
(86) PCT No.: PCT/CN2021/103552

§ 371 Date: Oct. 31, 2022

(30) Foreign Application Priority Data
Jun. 30, 2020 (CN) PCTCN2020099340
Sep. 8, 2020 (CN) PCTCN2020113898

(51) Int. Cl. H04W 72/20; H04W 24/02; H04L 5/00

(52) U.S. Cl. CPC H04W 72/20; H04L 5/001; H04W 24/02

(57) ABSTRACT

Certain aspects of the present disclosure provide techniques for an adaptive strategy for enhanced thermal mitigation and overheating signaling. A method that may be performed by a user equipment (UE) includes determining whether one or more trigger conditions are met and following an overheating assistance (OA) configuration received from a network or switching to an internal thermal mitigation configuration based at least in part on the determining.

### CROSS-REFERENCE TO RELATED APPLICATION(S)

This application claims benefit of and priority to International Patent Cooperation Treaty Application No. PCT/CN2020/099340, filed Jun. 30, 2020, and to International Patent Cooperation Treaty Application No. PCT/CN2020/113898, filed Sep. 8, 2020, both entitled “ADAPTIVE STRATEGY FOR ENHANCED THERMAL MITIGATION AND OVERHEATING ASSISTANCE SIGNALING,” which are assigned to the assignee hereof and hereby expressly incorporated by reference herein for all applicable purposes in their entirety as if fully set forth below.

### BACKGROUND

### Field of the Disclosure

Aspects of the present disclosure relate to wireless communications, and more particularly, to techniques for enhanced thermal mitigation and overheating assistance signaling.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New Radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

As the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved thermal mitigation and overheating signaling.

Certain aspects of the subject matter described in this disclosure can be implemented in a method for wireless communication by a user equipment (UE). The method generally includes determining whether one or more trigger conditions are met. The method generally includes following an overheating assistance (OA) configuration received from a network or switching to an internal thermal mitigation configuration based at least in part on the determining.

Certain aspects of the subject matter described in this disclosure can be implemented in another method for wireless communication by a UE. The method generally includes sending an OA request to a network indicating a set of one or more requested OA parameters. The method generally includes receiving, from the network, an OA configuration of one or more OA parameters. The method generally includes switching to an internal thermal mitigation configuration when the OA configuration is different than a UE preferred order of reduction.

Certain aspects of the subject matter described in this disclosure can be implemented in yet another method for wireless communication by a UE. The method generally includes determining a desired configuration comprising at least one of a requested number of uplink component carriers, a requested number of downlink component carriers, a requested total number of component carriers, a request bandwidth, a requested number of multiple input multiple output (MIMO) layers, or a combination thereof. The method generally includes signaling the desired configuration to a network via repurposed OA signaling during a duration when the UE is not experiencing an overheating condition.

Certain aspects of the subject matter described in this disclosure can be implemented in a method for wireless communication by a base station (BS). The method generally includes receiving an OA request from a UE indicating a set of one or more requested OA parameters. The method generally includes sending, to the UE, an OA configuration of one or more OA parameters in response to the OA request.

Certain aspects of the subject matter described in this disclosure can be implemented in a method for wireless communication by a BS. The method generally includes receiving an indication from a UE of a desired configuration comprising at least one of a requested number of uplink component carriers, a requested number of downlink component carriers, a requested total number of component carriers, a request bandwidth, a requested number of MIMO layers, or a combination thereof. The method generally includes configuring the UE in response to the indication from the UE.

Aspects of the present disclosure provide means for, apparatus, processors, and computer-readable mediums for performing the methods described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram illustrating an example telecommunications system, in accordance with the present disclosure.

FIG. 2 is a block diagram illustrating a design of an example a base station (BS) and user equipment (UE), in accordance with the present disclosure.

FIG. 3 is an example frame format for New Radio (NR), in accordance with the present disclosure.

FIG. 4 is a flow diagram illustrating example operations for wireless communication by a UE, in accordance with the present disclosure.

FIGS. 5A-5E are call flow diagrams illustrating example signaling for adaptive strategies for enhanced thermal mitigation, in accordance with the present disclosure.

FIG. 6 is a flow diagram illustrating example operations for wireless communication by a UE, in accordance with the present disclosure.

FIG. 7 is a flow diagram illustrating example operations for wireless communication by a BS, in accordance with the present disclosure.

FIG. 8 illustrates example indexing for signaling a preferred configuration of cell groupings to a BS.

FIG. 9 is a flow diagram illustrating example operations for wireless communication by a UE, in accordance with the present disclosure.

FIG. 10 is a flow diagram illustrating example operations for wireless communication by a BS, in accordance with the present disclosure.

FIG. 11 illustrates a communications device that may include various components configured to perform operations for the techniques disclosed herein in accordance with the present disclosure.

FIG. 12 illustrates a communications device that may include various components configured to perform operations for the techniques disclosed herein in accordance with the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for adaptive strategies for enhanced thermal mitigation and overheating assistance (OA) signaling.

Overheating can be detrimental to a user equipment (UE) device. When the thermal state of a UE becomes detrimental, it is desirable to quickly and properly mitigate the overheating to avoid damage to the UE. With the deployment of 5G/NR, which institutes higher data rates and wider bandwidth, UE thermal issues are more likely to occur as the processing burden and radio frequency usage of the UEs intensify.

According to certain aspects of the present disclosure, a UE may switch to an internal thermal mitigation algorithm, for example, when one or more trigger conditions are met. Aspects provide for the UE to provide information to the network indicating preferred OA parameters. Aspects provide for repurposing of OA signaling, for example, to indicate certain parameters even when the UE is not overheating.

The following description provides examples of adaptive strategies for enhanced thermal mitigation and OA signaling in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or New Radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may coexist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

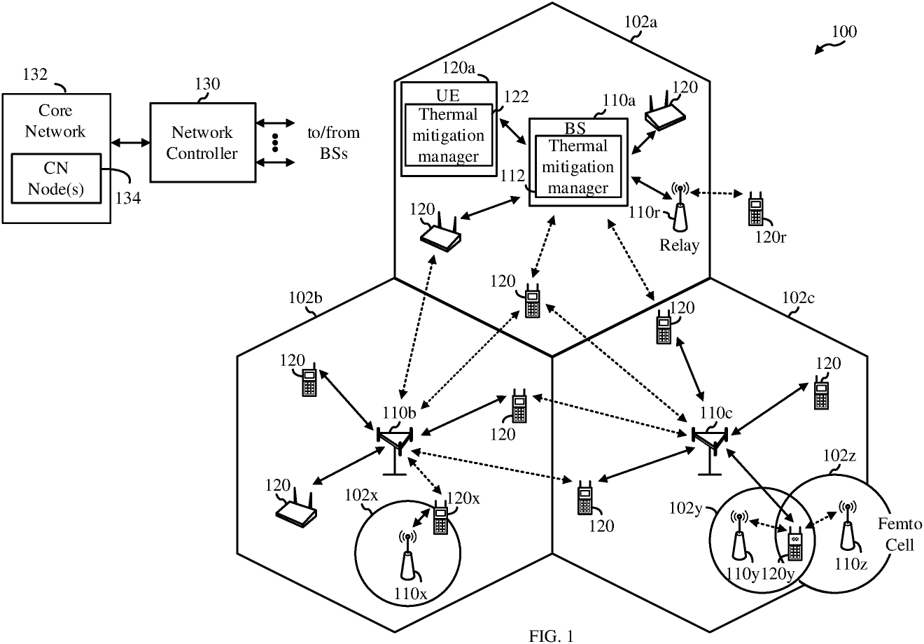

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces. The core network 132 may be composed of one or more core network nodes 134.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. A network controller 130 may couple to a set of BSs 110 and provide coordination and control for these BSs 110 (e.g., via a backhaul).

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays, relay BSs, or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

According to certain aspects, the BSs 110 and UEs 120 may be configured for thermal mitigation. As shown in FIG. 1, the BS 110a includes a thermal mitigation manager 112. The thermal mitigation manager 112 may be configured for adaptive strategies for enhanced thermal mitigation and OA signaling, in accordance with aspects of the present disclosure. As shown in FIG. 1, the UE 120a includes a thermal mitigation manager 122. The thermal mitigation manager 122 may be configured for adaptive strategies for enhanced thermal mitigation and overheating signaling, in accordance with aspects of the present disclosure.

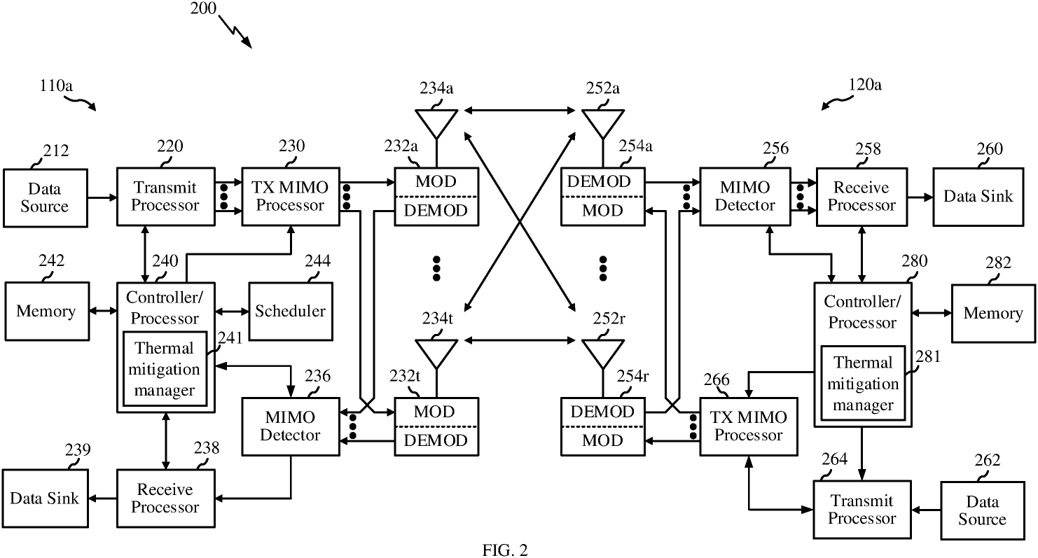

FIG. 2 illustrates example components of BS 110a and UE 120a (e.g., in the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a thermal mitigation manager 241 that may be configured for adaptive strategies for enhanced thermal mitigation and OA signaling, according to aspects described herein. As shown in FIG. 2, the controller/processor 280 of the UE 120a has a thermal mitigation manager 281 that may be configured for adaptive strategies for enhanced thermal mitigation and OA signaling, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz -7.125 GHz) and FR2 (24.25 GHz - 52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz - 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz - 24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz - 71 GHz), FR4 (52.6 GHz -114.25 GHz), and FR5 (114.25 GHz - 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

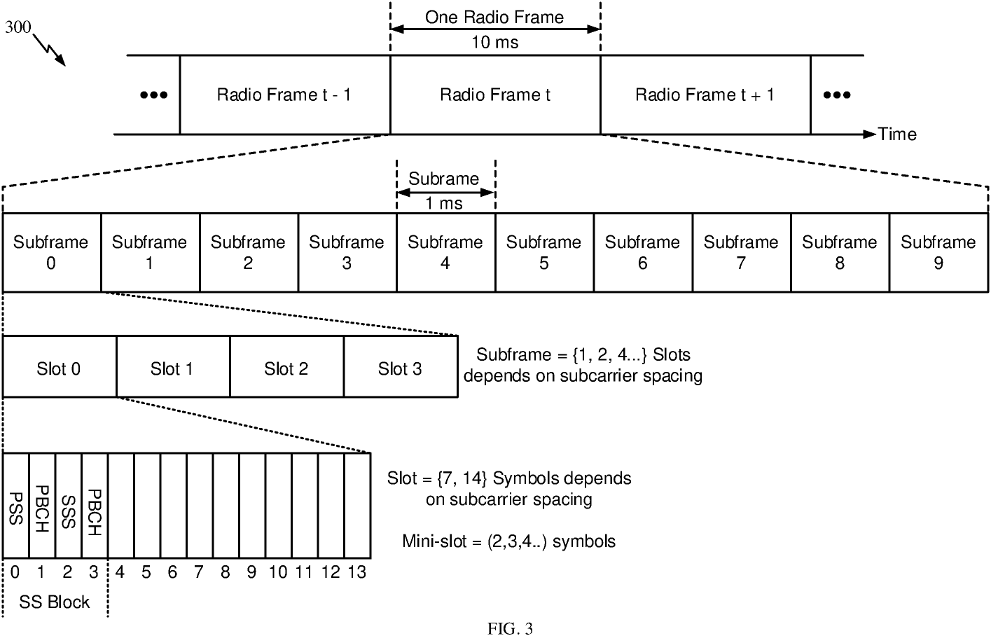

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, ... slots) depending on the SCS. Each slot may include a variable number of symbol periods (e.g., 7 or 14 symbols) depending on the SCS. The symbol periods in each slot may be assigned indices. “Mini-slot”, or “sub-slot structure”, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based at least in part on the slot format. Each slot may include DL/UL data as well as DL/UL control information.

As discussed above, aspects of the present disclosure relate to thermal mitigation and overheating assistance (OA) signaling.

In some systems (e.g., such as 5G NR), the UE may enable thermal mitigation with engagement from a BS. For example, the BS may provide certain parameters for thermal mitigation via OA signaling. As an illustrative example of OA signaling, certain OA signaling is defined in Release 16 of 3GPP Technical Specification (TS) 38.331. When initiating an OA request to a BS, a UE may include information to aid the network in determining a thermal mitigation configuration for the UE. An OA configuration may indicate one or more parameters, such as a maximum number of component carriers (CCs) in the downlink (DL) and/or the uplink (UL), a maximum bandwidth, and a maximum number of multiple input multiple output (MIMO) layers. The parameters may be provided separately for different frequency ranges (e.g., FR1, FR2, FR3, FR4, and so on). The CCs may be in a master cell group (MCG) and/or a secondary cell group (SCG). The CCs may be in a primary SGC cell (PSCell) or a secondary cell (SCell).

Based at least in part on the information from the UE, a BS may accept the OA configuration, return a different OA configuration, or delay response.

If overheating continues, the UE may send another OA request to the BS after the expiry of a prohibit timer. The prohibit timer defines a minimum time gap between the receipt or transmission of two consecutive UE OA request messages. The prohibit timer can be configured by a BS (e.g., via an “overheatingIndicationProhibitTimer” parameter). The UE may continue OA signaling until the overheating is alleviated. For example, the UE continues sending OA requests, after expiry of the prohibit timer, and receiving OA configurations from the BS until a temperature associated with the UE is lower than a threshold. Upon thermal alleviation, the UE may send OA signaling with “empty” information elements (IEs) to the BS, thus indicating that the temperature is lower than the threshold and OA can be halted.

This system for thermal mitigation is not always efficient. For example, the signaling associated with OA can involve significant overhead and can contribute to a thermal state of the UE. In addition, in some cases, it may be useful for the UE to indicate or modify configuration parameters associated with OA when the UE is not overheating, for example, to manage throughput or link coverage, and/or in other scenarios.

Techniques and apparatuses described herein provide an adaptive strategy for enhanced thermal mitigation and overheating signaling that promote efficient alleviation of overheating, efficient communication between a UE and a BS in determining the desired OA configuration, and improved UE device performance. Thus, thermal mitigation at the UE is improved, overhead associated with OA signaling is reduced, and UE performance is improved.

Aspects of the present disclosure provide adaptive strategies for thermal mitigation and OA signaling. In some examples, a UE can adaptively implement one or more internal thermal mitigation algorithms (e.g., modes) based at least in part on one or more trigger conditions. For example, the UE may switch to an internal thermal mitigation algorithm (e.g., mode) where an OA configuration received from a BS is insufficient to mitigate overheating at the UE. For example, if the BS does not respond to an OA request from the UE, if the BS fails to provide an OA configuration that alleviates the overheating, or if the BS delays its response, then the UE may switch to an internal thermal mitigation algorithm. Where the BS responds to an OA request from the UE, within a threshold duration, and with an OA configuration sufficient to alleviate the overheating, then the UE may follow the OA configuration received from the BS rather than switching to an internal thermal mitigation algorithm. In some cases, the UE may follow the configuration from the BS in part, and follow a UE preference or an internal thermal mitigation algorithm in part. In some aspects, the internal thermal mitigation algorithm is more aggressive than an OA configuration received from the BS. For example, the internal thermal mitigation algorithm may involve one or more parameters of the OA configuration and/or one or more parameters not included in the OA configuration. The parameters of the internal thermal mitigation algorithm may configure the UE to alleviate a temperature condition more quickly than an OA configuration, such as by releasing a larger number of subcarriers or more aggressively limiting bandwidth or MIMO layers.

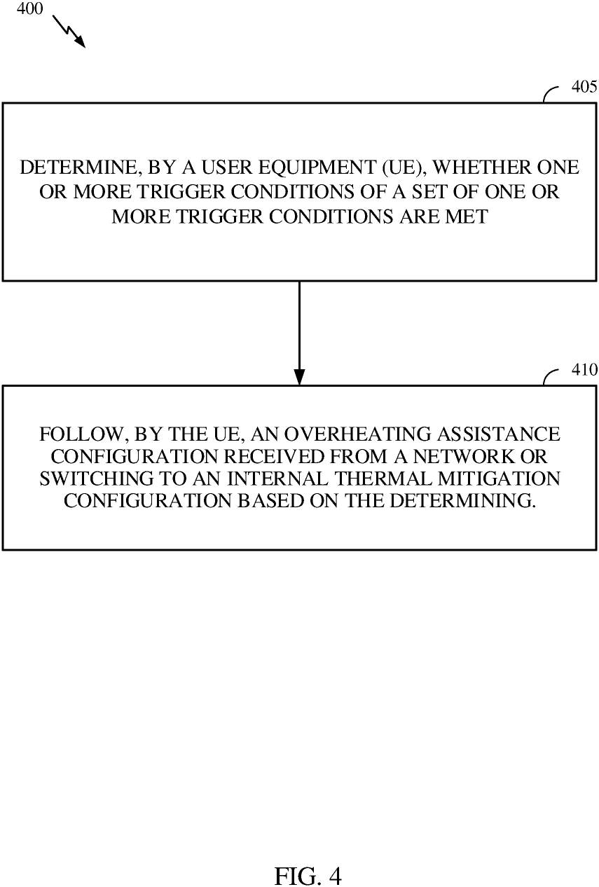

FIG. 4 is a flow diagram illustrating example operations 400 for wireless communication, in accordance with certain aspects of the present disclosure. The operations 400 may be performed, for example, by UE (e.g., such as a UE 120a in the wireless communication network 100). Operations 400 may be implemented as software components that are executed and run on one or more processors (e.g., controller/processor 280 of FIG. 2). Further, the transmission and reception of signals by the UE in operations 400 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 400 may begin, at 405, by a UE determining whether one or more trigger conditions of a set of one or more trigger conditions are met.

In some examples, a trigger condition is based at least in part on a determination that the network does not support OA signaling. For example, the UE may determine whether the network supports OA signaling based at least in part on whether the network configured the UE for sending an OA request indicating a set of one or more requested OA parameters. If the network does not support OA signaling, then a trigger condition may be satisfied.

In some examples, a trigger condition is based at least in part on a determination that the UE has not received the OA configuration from the network within a threshold duration. The UE may determine whether the UE receives the OA configuration from the network within the threshold duration by: sending an OA request to the network indicating a set of one or more requested OA parameters; starting a timer of the threshold duration after sending the OA request; and determining whether the UE receives the OA configuration from the network before expiry of the timer. If the UE does not receive the OA configuration before expiry of the timer, then a trigger condition may be satisfied.

In some examples, a trigger condition is based at least in part on the UE receiving the OA configuration from the network that does not include one or more OA parameters requested by the UE. For example, the UE may send an OA request to the network indicating a set of one or more requested OA parameters. The UE may receive the OA configuration from the network. The UE may determine whether the OA configuration includes the set of one or more requested OA parameters. In some examples, the set of one or more trigger conditions includes an insufficient value for at least one of the one or more OA parameters requested by the UE. For example, the UE may request a maximum of 2 MIMO layers, and the OA configuration from the network may indicate a maximum of 3 MIMO layers. In this case, a trigger condition may be satisfied. In some aspects, the UE may take into account all previously received OA parameters, de-configuration commands, and de-activation commands from the network when determining whether the network provides a sufficient configuration and/or when determining whether the network responds quickly enough to the OA request. The determining may be performed upon expiry of the timer, upon receiving a first de-configuration command from the network, or upon receiving a first de-activation command from the network.

In some examples, a trigger condition is based at least in part on the UE being configured with a prohibit timer value larger than a threshold timer value. A prohibit timer that is too long may hamper the UE’s thermal mitigation, since the UE may be unable to request a more aggressive OA configuration until the prohibit timer has elapsed. The UE may determine the threshold timer value based at least in part on a UE OA tolerance capability. The UE OA tolerance capability may indicate a tolerance of the UE with regard to delay in updating an OA configuration.

In some examples, the set of one or more trigger conditions includes the UE reaching a thermal threshold. For example, the UE may determine whether a UE temperature exceeds a maximum thermal threshold. If the UE determines that a UE temperature exceeds a maximum thermal threshold, then a trigger condition may be satisfied. The maximum thermal threshold may be different than a thermal threshold associated with initiating OA request or configuration. For example, the maximum thermal threshold may be higher than the thermal threshold associated with initiating OA request or configuration.

In some examples, the set of one or more trigger conditions includes a combination of any two or more of the above trigger conditions. In some aspects, the set of one or more trigger conditions may be determined by the UE. In some aspects, the set of one or more trigger conditions may be configured by the base station. In some aspects, the set of one or more trigger conditions may be preconfigured for the UE, such as by an original equipment manufacturer.

At 410, the UE follows an OA configuration received from a network or switches to an internal thermal mitigation configuration based at least in part on the determining. In some examples, the OA configuration indicates one or more OA parameters. For example, the one or more OA parameters may include a number of uplink CCs, a number of downlink CCs, a maximum bandwidth, a maximum number of MIMO layers, or a combination thereof, as described elsewhere herein. The internal thermal mitigation configuration may be an internal thermal mitigation algorithm.

In some examples, the UE follows the OA configuration received from the network when none of the set of one or more trigger conditions is met, and the UE switches to the internal thermal mitigation configuration when the one or more trigger conditions are met. In some aspects, the UE may follow the internal thermal mitigation configuration until overheating is alleviated (e.g., until a temperature threshold is no longer satisfied). In some other aspects, the UE may follow the internal thermal mitigation configuration until after a threshold number of iterations of an internal thermal mitigation algorithm associated with the thermal mitigation configuration. In some other aspects, the UE may follow the internal thermal mitigation configuration until a temperature of the UE is below a maximum threshold temperature. In some other aspects, the UE may follow the internal thermal mitigation configuration until an OA configuration is received from the network that indicates a mobility change, that indicates the network supports OA signaling, that configures a prohibit timer value within a threshold timer value, or a combination thereof. For example, the UE may follow the internal thermal mitigation configuration until one or more of the trigger conditions are no longer satisfied.

In some examples, the UE may send an OA request to the network indicating a set of one or more requested OA parameters. For example, the OA request may indicate a preferred order of reduction for one or more OA parameters. An order of reduction indicates a magnitude of a reduction (e.g., decrease the maximum number of MIMO layers by 1) and/or particular carriers or bandwidth to deactivate or reduce (e.g., reduce bandwidth in FR2, deactivate CCs X and Y). The UE may receive, from the network, an OA configuration of one or more OA parameters. The UE may switch to an internal UE configuration when the OA configuration is different than a UE preferred order of reduction. In some examples, the OA configuration from the network indicates CCs to be reduced, and the internal UE configuration reduces different CCs that the CCs indicated by the network and corresponding to the same number of reduced CCs. According to certain aspects, the UE may send the network an indication of a preferred order of reduction corresponding to an order of preference for cell groups, CCs, or both to be reduced. The UE may indicate weights associated with the preferred order of reduction.

The UE may send an indication to the network that overheating is alleviated and including a set of one or more requested OA parameters. The UE may send the indication via OA signaling. In some aspects, the UE may send the signaling in response to determining that an overheating condition is alleviated. In some aspects, the signaling is repurposed OA signaling that is transmitted based at least in part on determining that a change in one or more parameters is desired. For example, the UE may determine that a coverage level is below a threshold, that secondary cell (SCell) quality is degraded to satisfy a threshold, that SCell timing has drifted to satisfy a threshold, that a cyclic prefix format is incorrect, that an interference condition associated with one or more SCells is satisfied, that there is a persistent lack of resources for communications of the UE, or a combination thereof. Based at least in part on this determination, the UE may transmit repurposed OA signaling, as described elsewhere herein.

According to certain aspects, the UE may receive multiple thermal indications from multiple thermal monitors. A thermal monitor is a component of the UE that provides temperature information in the form of a thermal indication. For example, if a temperature detected by the thermal monitor satisfies a threshold, the thermal monitor may provide a thermal indication to the UE. In some aspects, the UE may queue multiple thermal indications and send OA signaling for each thermal indication separately, which reduces processing burden at the UE. In some other aspects, the UE may start a combination timer, receive multiple thermal indications from multiple thermal monitors while the combination timer is running, combine the multiple thermal indications, and send OA signaling for the combined thermal indications. For example, the UE may start a combination timer upon receiving a first thermal indication of the multiple thermal indications, or may start the combination timer prior to receiving the first thermal indication (e.g., periodically, etc.). A combination timer is a timer that indicates a length of time within which a UE can combine multiple thermal indications.

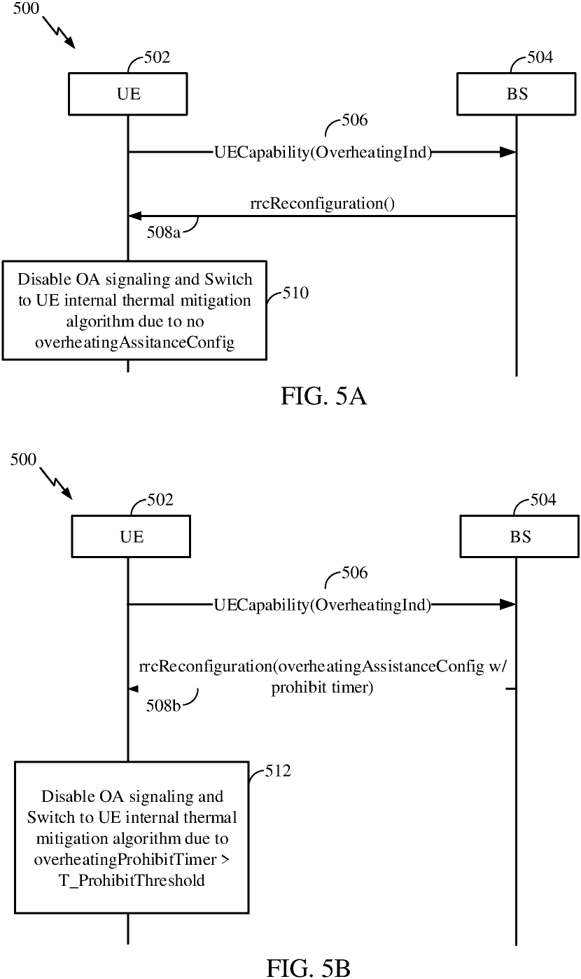

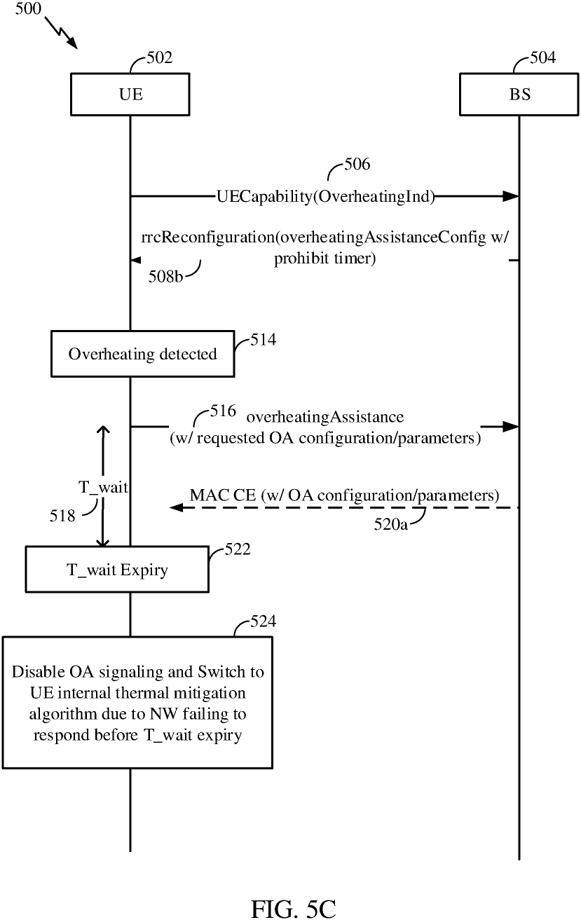

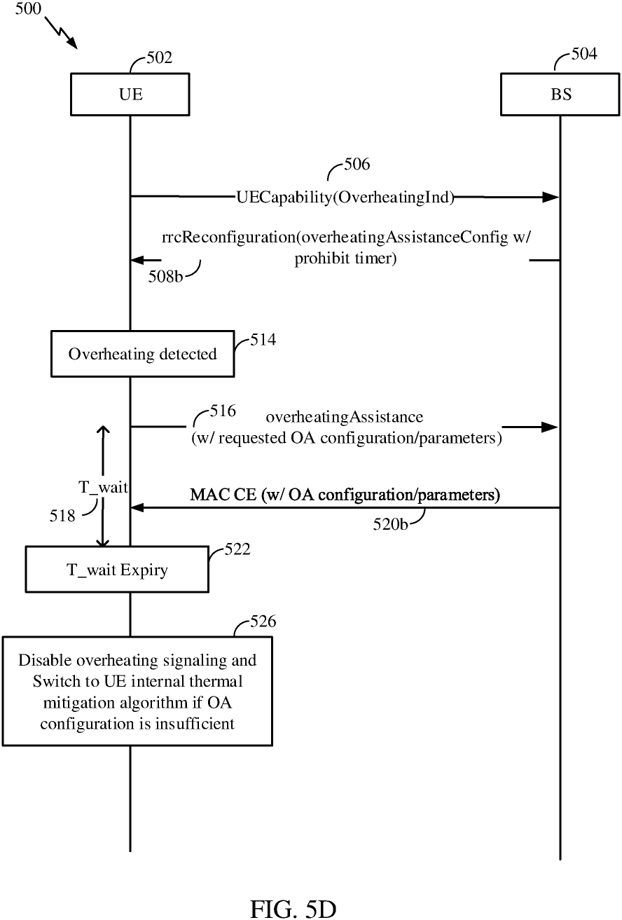

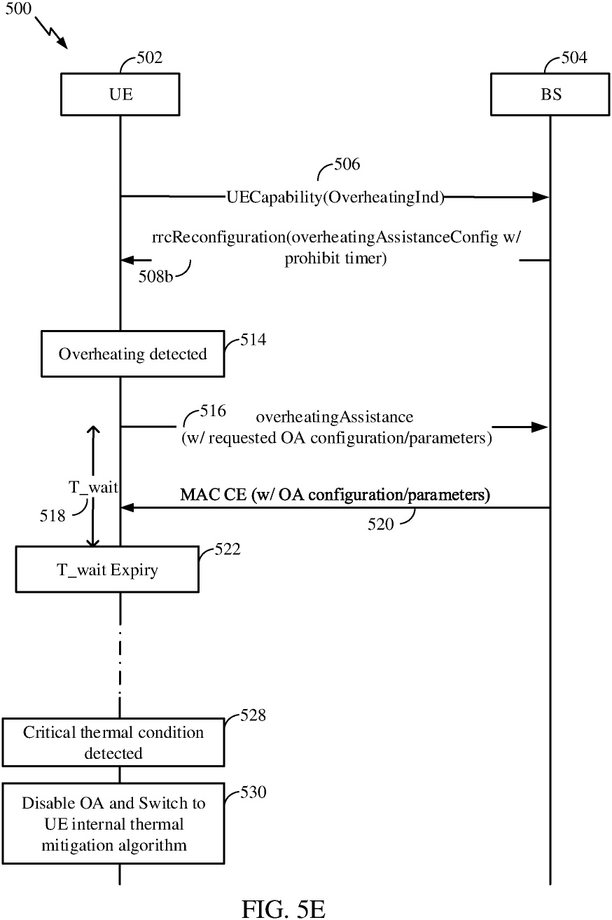

According to aspects of the present disclosure, a UE may apply adaptive strategies that allow the UE to adaptively apply an internal thermal mitigation algorithm, such as where a thermal mitigation configuration from a BS is ineffective to mitigate overheating. For example, a UE may follow a BS OA configuration if the BS responds timely and sufficiently to a UE thermal mitigation request such as an OA request. However, the UE may switch to its own internal thermal mitigation algorithm if the BS does not respond, has a delayed response, does not sufficiently respond (such as when the OA configuration is insufficient to manage the UE’s thermal condition), or when overheating satisfies a maximum thermal threshold. FIGS. 5A-5E are call flows illustrating examples of an adaptive switch to an internal thermal mitigation algorithm/configuration and trigger conditions for the adaptive switch.

FIG. 5A illustrates switching to one or more internal thermal mitigation algorithms when the BS does not support OA signaling. As illustrated in FIG. 5A at 506, a UE 502 (e.g., UE 120) may send a message, such as a UE capability message, to the BS 504 (e.g., BS 110). The UE capability message may indicate the UE 502’s capability for OA signaling. The BS 504 may not support OA signaling. In this scenario, the BS 504 sends a message, such as the radio resource control (RRC) reconfiguration message, to the UE 502 indicating that the BS 504 does not support OA signaling. For example, at 508a, the BS 504 does not include an “overheatingAssistanceConfig” parameter in its response to the message to the UE 502. Thus, the UE 502 can determine that the BS 504 does not support OA signaling when the overheatingAssistanceConfig parameter is absent in the message from the BS. In this case, the UE 502 may switch to one or more internal thermal mitigation algorithms at 510.

FIG. 5B illustrates switching to one or more internal thermal mitigation algorithms when the BS configures a prohibit timer that is too large. In some systems (e.g., certain 5G NR systems), the UE may send a next thermal mitigation request (e.g., an OA request) to the BS after the expiry of a prohibit timer. The prohibit timer is a timer triggered by the UE after the UE transmits a first thermal mitigation request. The prohibit timer may be configured by the BS. For example, the prohibit timer may be configured in an RRC reconfiguration message from the BS (such as the message at 508 of FIG. 5A). In some examples, the prohibit timer may be up to 600 seconds. Thus, an OA response configuration with a 600 second prohibit timer might allow a UE to overheat for 10 minutes without proper mitigation. This may be detrimental to UE functionality.

As illustrated in FIG. 5B, the BS 504 may send the RRC reconfiguration message, at 508b, with overheating assistance configuration (indicating the BS 504 supports OA signaling) and including a prohibit timer (e.g., a configuration with a parameter “overheatingIndicationProhibitTimer” that indicates a duration of the prohibit timer). The configured prohibit timer may have a duration that is too long to enable effective thermal mitigation. For example, the UE 502 may determine that the prohibit timer configured at 508b is larger (e.g., has a timer duration value) than a timer value threshold (e.g., T_switch_prohibit). In this case, the UE 502 may switch to one or more internal thermal mitigation algorithms at 512. The UE 502 may determine the threshold based at least in part on an upper time limit that the UE tolerates an excessive thermal state without taking further actions (e.g., T_switch_prohibit might be around 20 seconds). The prohibit timer threshold trigging to switch to an internal thermal mitigation algorithm (at 512) may allow the UE 502 to overcome persistent overheating issues that may continue after a first thermal mitigation request (at 506).

FIG. 5C illustrates switching to an internal thermal mitigation algorithm when the BS sends a delayed OA configuration. As illustrated in FIG. 5C, the BS 504 may support OA signaling (e.g., indicated at 508b). After OA signaling is configured (not shown), the UE 502 may detect an overheating condition, at 514. The UE 502 may then send the BS 504 a thermal mitigation request message indicating OA information, at 516. For example, the OA information may include a requested OA configuration, such as one or more OA parameters requested by the BS 504. After sending the OA assistance information, at 516, the UE 502 may start a timer, such as the T_wait timer 518. The UE 502 may switch to an internal thermal mitigation algorithm at 524, if the BS 504 does not respond to the thermal mitigation request before expiry of the timer at 522. For example, in some cases, the BS 504 may not transmit a MAC control element (CE) with OA parameters to the UE 502 within T_wait, and the UE may switch to the internal thermal mitigation algorithm. The length of T_wait may be configurable. The T_wait timer may reflect the processing time and/or reaction delay for the BS to respond to thermal mitigation requests. The length of the T_wait timer may be chosen by the UE, by the BS, or negotiated by the UE and the BS. If the UE 502 receives a response from the BS 504 before expiry of the timer, the UE may follow the configuration of the BS. For example, at 520a, the BS 504 may send a MAC CE to the UE 502 before expiry of the timer at 522. The MAC CE may include an OA configuration (e.g., one or more OA parameters) for the UE. The dashed line indicates that, in some cases, the BS 504 may not send the MAC CE within T_wait, so the UE may switch to internal thermal mitigation.

FIG. 5D illustrates switching to an internal thermal mitigation algorithm when the BS sends an insufficient OA configuration (e.g., insufficient to alleviate the overheating). As illustrated in FIG. 5D, the BS 504 may support OA signaling (e.g., indicated at 508b) and may respond, at 520b, to the thermal mitigation request (e.g., sent at 516) before expiry of the timer (at 522). As mentioned above, the response at 520b may include an OA configuration for the UE. However, if the OA configuration response 508b fails to sufficiently honor the requested configuration of the thermal mitigation request at 516, then UE 502 may switch to one or more internal thermal mitigation algorithms at 526. In an illustrative example, a UE may have seven active SCCs and may send a thermal mitigation request that asks the BS to reduce the number of active SCCs to two. However, the BS 504 may only deactivate or deconfigure one of the SCCs (or in general, less than the requested reduction). In this case, the UE may switch to one or more internal thermal mitigation algorithms. This example may also be applicable to a bandwidth reduction (where the BS 504 does not sufficiently reduce a bandwidth of the UE 502) and/or MIMO layer reduction (where the BS 504 does not sufficiently reduce a number of MIMO layers of the UE 502).

According to certain aspects, the UE 502 may account for multiple (e.g., all) deconfiguration and/or deactivation commands when evaluating the sufficiency of an OA configuration from the BS 504. The UE 502 may set a timer (e.g., the T_wait timer) and determine the sufficiency of the OA configuration based at least in part on commands received before expiry of the timer. Alternatively, the UE 502 may determine the sufficiency of the OA configuration upon receiving a deconfiguration or deactivation command. In an illustrative example, the UE 502 may send a request for a reduction of SCCs from seven to two. Prior to receiving a response configuration from the BS 504, the UE 502 may receive deactivation (e.g., via a MAC-CE) of two SCCs. Then, the UE 502 may receive an OA response configuration from the BS with a “deconfiguration” of three SCCs. As a result, the UE 502 has five SCCs deactivated and/or deconfigured, meeting the UE 502’s OA configuration request. In this case, the UE may not switch to an internal thermal mitigation algorithm.

FIG. 5E illustrates switching to an internal thermal mitigation algorithm when a thermal condition occurs. As illustrated in FIG. 5E, a UE 502 may reach a thermal condition at 528. For example, the UE 502 may determine that a temperature level at the UE exceeds a maximum threshold temperature. In some aspects, a UE 502 may have multiple temperature threshold levels (e.g., levels at multiple different temperatures, such as in one example at 90° F., 95° F., and 100° F.) associated with different thermal mitigation algorithms. Accordingly, at 530, the UE may disable the OA configuration and/or switch to an internal thermal According to certain aspects, after switching, the UE may continue using the internal thermal mitigation algorithm until overheating is alleviated. After the overheating is alleviated, the UE may return to OA signaling with the BS and/or switch to the OA configuration received from the BS. For example, the UE may use the internal thermal mitigation algorithm until the UE temperature drops to a lower level of thermal condition (e.g., below an acceptable threshold), and then may switch to the OA configuration.

According to certain aspects, after switching, the UE may continue using the internal thermal mitigation algorithm until after a number, N, of iterations of one or more actions associated with using the UE’s internal thermal mitigation algorithm (here, N≥1). An example of the action may include one measurement of temperature and the corresponding actions associated with the measurement (e.g., locally deactivating a certain number of SCCs).

According to certain aspects, after switching, the UE may continue using the internal thermal mitigation algorithm until the UE receives a new OA configuration from the BS indicating that the trigger condition that prompted the switching no longer exists (e.g., is no longer satisfied). For example, the UE may receive signaling from the BS indicating that OA signaling is supported by the BS. In another example, the UE may receive signaling indicating that the prohibit timer has been (re)configured to a shorter value (e.g., below the threshold timer value). In another example, the UE may receive an indication of a mobility change, such as an indication that a handover has occurred.

According to aspects of the present disclosure, a UE may send a BS a preferred order of reduction.

As discussed above, in a response to a thermal mitigation request, a BS may send an OA configuration. The OA configuration may reduce in a different order than what the UE may prefer. For example, the OA configuration may include a reduced number of CCs for the DL and/or UL, a reduced bandwidth, reduced MIMO layers, or the like. However, the UE may have a preferred order in which to disable CCs that is different from the order provided by a BS. For example, the order may be based at least in part on relative importance of the CCs, ongoing traffic associated with one or more of the CCs, respective temperature impacts of the CCs, respective bandwidths or subcarrier spacings of the CCs, respective traffic profiles of the CCs, or the like. According to certain aspects, the UE may be able to indicate an amount of reduction and a preference of the specific CCs, bandwidth, and/or MIMO layers for reduction. In some examples, the UE can indicate a priority and/or weights associated with the reduction. In such examples, the BS may deactivate CCs, bandwidth, and/or MIMO layers based at least in part on the priority and/or weights.

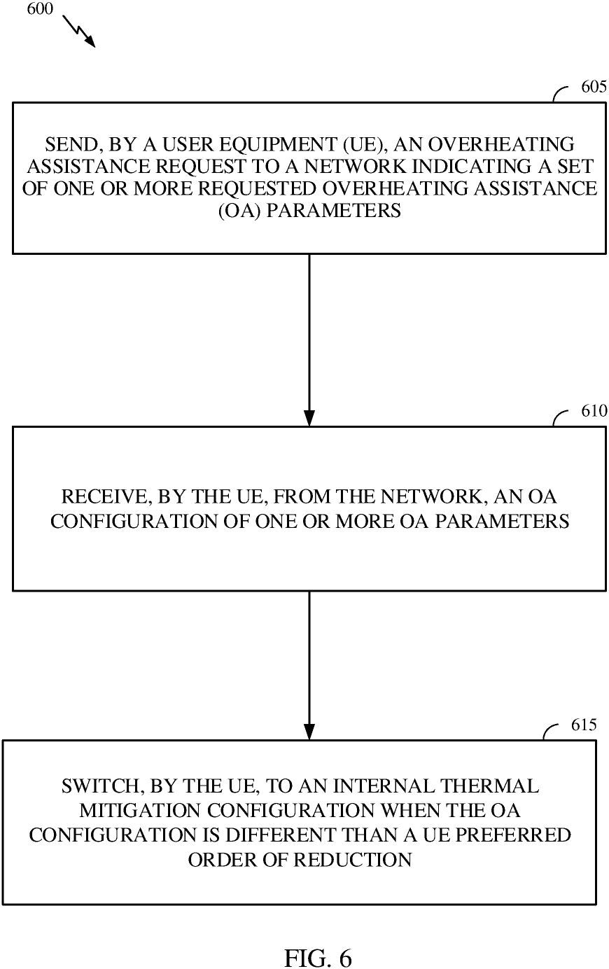

FIG. 6 is a flow diagram illustrating example operations 600 for wireless communication, in accordance with certain aspects of the present disclosure. The operations 600 may be performed, for example, by UE (e.g., such as a UE 120a in the wireless communication network 100). Operations 600 may be implemented as software components that are executed and run on one or more processors (e.g., controller/processor 280 of FIG. 2). Further, the transmission and reception of signals by the UE in operations 600 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 600 may begin, at 605, by a UE sending an OA request to a network indicating a set of one or more requested OA parameters, as described in more detail elsewhere herein. In some aspects, the OA request may indicate a set of CCs to be reduced (e.g., deactivated, deconfigured). In some other aspects, the OA request may indicate a number of CCs to be reduced. For example, the UE may have information indicating a preferred order in which to deactivate or deconfigure CCs, and may, or may not, signal this information to the network.

At 610, a UE may receive, from the network, an OA configuration of one or more OA parameters. The OA configuration from the network indicates CCs to be reduced. The internal UE configuration reduces different CCs that the CCs indicated by the network and corresponding to the same number of reduced CCs. For example, if the UE requests that 3 CCs be reduced, then the OA configuration may indicate 3 CCs to be reduced, but these 3 CCs may at least partially differ from a set of 3 CCs preferred by the UE for deactivation, as identified by a UE preferred order of reduction.

At 615, a UE may switch to an internal thermal mitigation configuration (e.g., algorithm) when the OA configuration is different than a UE preferred order of reduction. For example, the UE may switch to the internal thermal mitigation configuration when the OA configuration differs from the UE preferred order of reduction to any degree. As another example, the UE may switch to the internal thermal mitigation configuration when a difference between the OA configuration and the UE preferred order of reduction satisfies a threshold (e.g., when at least N CCs are deactivated out of order). As yet another example, the UE may switch to the internal thermal mitigation configuration based at least in part on an impact of the OA configuration, such as based at least in part on the OA configuration indicating to deactivate a CC that is preferred by the UE as an active CC.

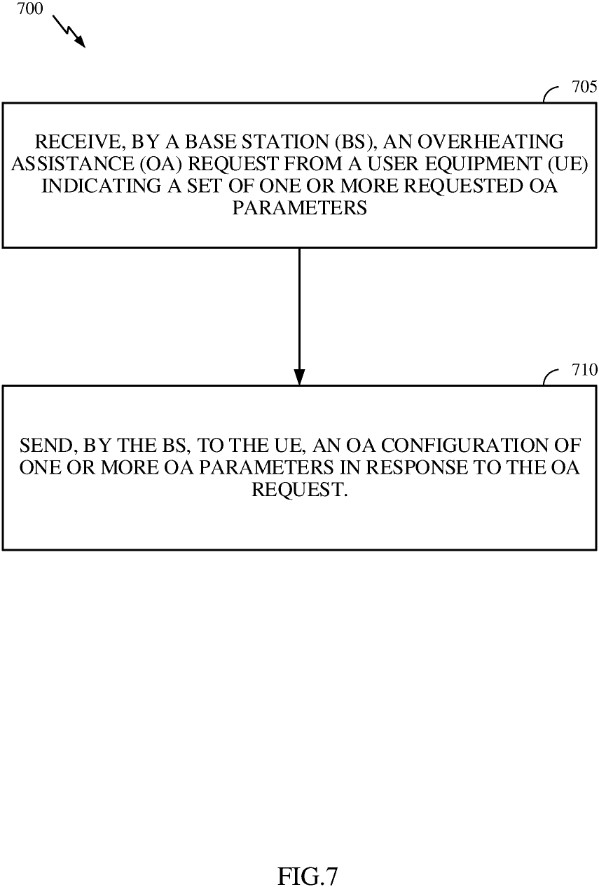

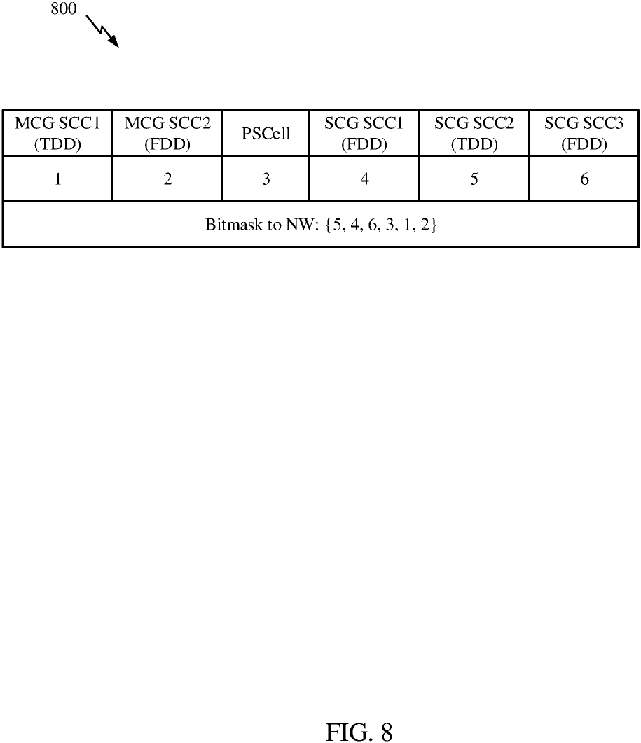

FIG. 7 is a flow diagram illustrating example operations 700 for wireless communication, in accordance with certain aspects of the present disclosure. The operations 700 may be performed, for example, by a BS (e.g., such as the BS 110a in the wireless communication network 100). Operations 700 may be implemented as software components that are executed and run on one or more processors (e.g., controller/processor 240 of FIG. 2). Further, the transmission and reception of signals by the BS in operations 700 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 700 may begin, at 705, by a BS receiving an OA request to a network indicating a set of one or more requested OA parameters, as described in more detail elsewhere herein. In some aspects, the OA request may indicate a set of CCs to be reduced (e.g., deactivated, deconfigured). In some other aspects, the OA request may indicate a number of CCs to be reduced. For example, the UE may have information indicating a preferred order in which to deactivate or deconfigure CCs, and may, or may not, signal this information to the network.

At 710, a BS may send, to the UE, an OA configuration of one or more OA parameters in response to the OA request. For example, if the UE requests that 3 CCs be reduced, then the OA configuration may indicate 3 CCs to be reduced, but these 3 CCs may at least partially differ from a set of 3 CCs preferred by the UE for deactivation, as identified by a UE preferred order of reduction.

In some examples, the OA configuration from the network indicates CCs to be reduced. An internal thermal mitigation configuration at the UE may reduce different CCs that the CCs indicated by the network and corresponding to the same number of reduced CCs.

In a dual-connectivity case (e.g., dual LTE and 5G connectivity), a UE may prefer to reduce a secondary cell group (SCG) configuration first, while the BS may indicate to reduce a master cell group (MCG) first. In another example, in a carrier aggregation case, a UE may prefer to reduce frequency division duplex (FDD) secondary component carriers (SCCs) first, while the BS may indicate to reduce time division duplex (TDD) SCCs first. In either case, the UE may switch to the internal thermal mitigation algorithm to enable a UE preferred configuration. In another example, the UE may apply an internal mitigation algorithm for one cell group (CG) (e.g., SCG) while complying with a BS configuration for another CG (e.g. MCG).

According to certain aspects of the present disclosure, a UE may send an explicit signal to the BS with its preferred order of reduction. As illustrated in FIG. 8, a bitmask 800 contains indexing of the CG(s) and/or CC(s) and/or weight. This bitmask 800 is sent from the UE to the BS to indicate its preferred order of reduction. Weights may be added to the bitmask 800 to indicate the preference (e.g., higher weight means more preferred to be disabled). In some aspects, the bitmask 800 may allow equivalent weights. In one example, the bitmask 800 may indicate an MCG (i.e., one primary component carrier (PCC) and two SCCs) and an SCG (i.e., one PCC and three SCCs). In some aspects, the bitmask 800 may indicate whether the UE prefers to reduce the SCG first or the MCG first. In some aspects, the bitmask 800 may indicate whether the UE prefers to reduce TDD cells first or FDD cells first. In some aspects, the bitmask 800 may indicate particular SCCs that the UE prefers to reduce.

According to certain aspects, a UE may send an implicit signal to the BS indicating the preferred order of reduction. An implicit signal is a signal that does not carry information identifying which CCs are to be reduced or a preferred order. In some examples, the UE can send an “out of range” value of a parameter to indicate the preferred order. For example, the UE may use an “out of range” channel quality indicator (CQI) value, such as CQI = 0 (which may indicate an “abnormal” or “special” condition at the UE), to indicate to the network which SCCs are to be reduced (e.g., deactivated, deconfigured). For example, the UE may send the indication (CQI = 0) per-CC, where each SCell to be removed can be indicated by a separate indication (e.g., a CQI = 0 for each SCell to be removed).

In some cases, the UE may send the indication (e.g., CQI = 0) earlier than the OA signaling. This may allow the network to respond once the network receives the OA signaling from the UE, because the network has received information indicating which SCells to reduce for the UE. In some cases, additionally or alternatively, the UE may send the indication (e.g., CQI = 0) after the OA signaling (for example, if the CQI trigger is aperiodic). An aperiodic CQI trigger may come at random or aperiodic times. The UE may extend the T_wait timer in this case to account for the delay in sending the CQI = 0 indication.

According to certain aspects, the UE may use a combination of the bitmask and CQI = 0 approaches to indicate the preferred order of reduction. The UE may dynamically choose whether to use a bitmask or CQI = 0 to indicate CCs to be reduced. In some examples, the UE may determine to use the bitmask or CQI = 0 based at least in part on whether the CQI report is configured on the SCells that the UE has determined to remove. For example, if the CQI report is not configured on the SCells that the UE has determined to remove, then the UE may use the bitmask to indicate the preferred order of reduction (e.g., because the UE cannot send out CQI for the SCell(s)). Additionally, the UE may determine to use the bitmask or CQI = 0 based at least in part on whether the CQI report sent on SCells that the UE has determined to remove is configured as periodic or aperiodic. If the CQI report is aperiodic, the UE may use the bitmask to indicate the preferred order of reduction (e.g., because an aperiodic CQI report comes at random or aperiodic times and may come too late). If the CQI report is periodic, the UE may use the CQI = 0 to indicate the preferred order of reduction. In some aspects, the determination of whether to use the bitmask or CQI=0 may be based at least in part on other factors.

In some cases, the UE may (e.g., by default) enable both the bitmask and CQI = 0 approaches simultaneously. In this case, the UE can operate without regard for whether CQI reporting is configured or whether the configuration has been changed/updated over time on the concerned SCells that the UE wants to remove. Additionally, the UE can operate without regard for which release the network supports.

According to certain aspects, a UE may utilize OA signaling to transmit a desired configuration to a BS. For example, the OA signaling may be repurposed to indicate the desired configuration, even when the UE is not overheating, has not been overheating for a long duration, and/or has never experienced overheating. For example, the UE may be able to use the OA signaling (e.g., the defined OA request/response signaling structure/format) to indicate a desired CC configuration, bandwidth, and/or number of MIMO layers, to the BS. In one example, the UE may indicate CCs for deactivation/disabling via OA signaling. In another example, the UE may indicate an increased or reduced configuration via OA signaling. In yet another example, the UE may indicate a preferred order of reduction for the desired configuration via OA signaling.

In some aspects, once heating is alleviated, the UE may send a desired configuration to the BS. For example, the UE may transmit a desired configuration in place of one or more empty information elements (IEs).

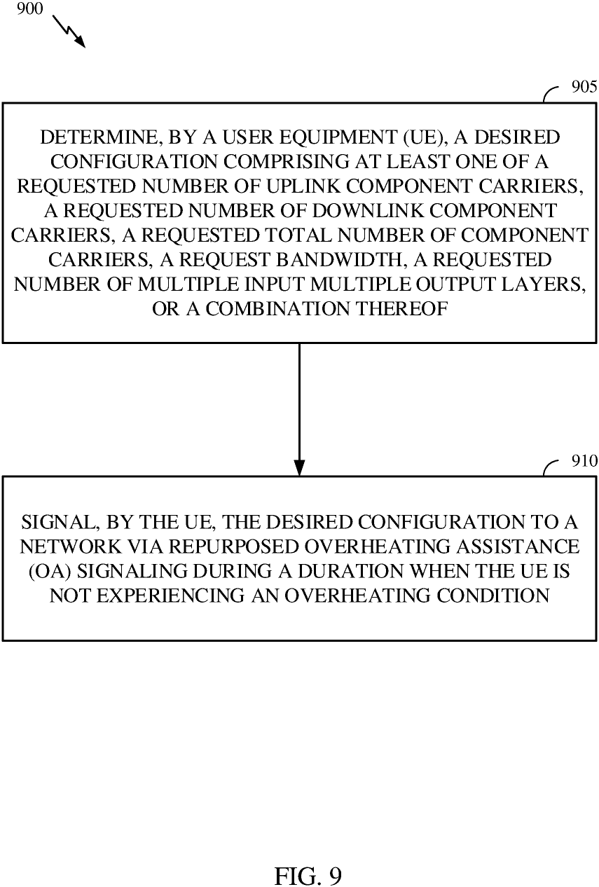

FIG. 9 is a flow diagram illustrating example operations 900 for wireless communication, in accordance with certain aspects of the present disclosure. The operations 900 may be performed, for example, by UE (e.g., such as a UE 120a in the wireless communication network 100). Operations 900 may be implemented as software components that are executed and run on one or more processors (e.g., controller/processor 280 of FIG. 2). Further, the transmission and reception of signals by the UE in operations 900 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

At 905, a UE may determine a desired configuration comprising at least one of a requested number of uplink component carriers, a requested number of downlink component carriers, a requested total number of component carriers, a request bandwidth, a requested number of MIMO layers, or a combination thereof.

At 910, the UE may signal the desired configuration to a network via OA signaling during a duration when the UE is not experiencing an overheating condition. For example, the UE may signal the desired configuration via repurposed OA signaling.

According to certain aspects, the UE may determine one or more conditions in which a different configuration is desirable. The UE may determine to request a configuration when the UE determines that a coverage level is below a threshold. For example, the UE may determine that quality associated with one or more SCells is below a threshold, and that disabling the one or more SCells may save power. The UE may determine that the quality is below the threshold based at least in part on receiving a threshold number of out-of-sync indications for the one or more SCells. As another example, the UE may determine to request a configuration based at least in part on a determination that SCell timing has drifted beyond a threshold. As yet another example, the UE may determine to request a configuration when the UE determines that a configured cyclic prefix format is incorrect. As still another example, the UE may determine to request a configuration when the UE determines an interference condition associated with one or more SCells. For example, multiple technologies such as Wi-Fi, licensed assisted access (LAA), NR unlicensed spectrum (NR-U), and/or other technologies may coexist. In some aspects, the interference condition may be related to coexistence. Additionally, or alternatively, the interference may be related to full-duplex communication, cross-link interference, self-interference, or the like. As another example, the UE may determine to request a configuration when the UE determines a persistent lack of resources. For example, a persistent lack of resources may occur for a subscriber identity module (SIM) card due to usage of resources by another SIM card in a multi-SIM scenario.

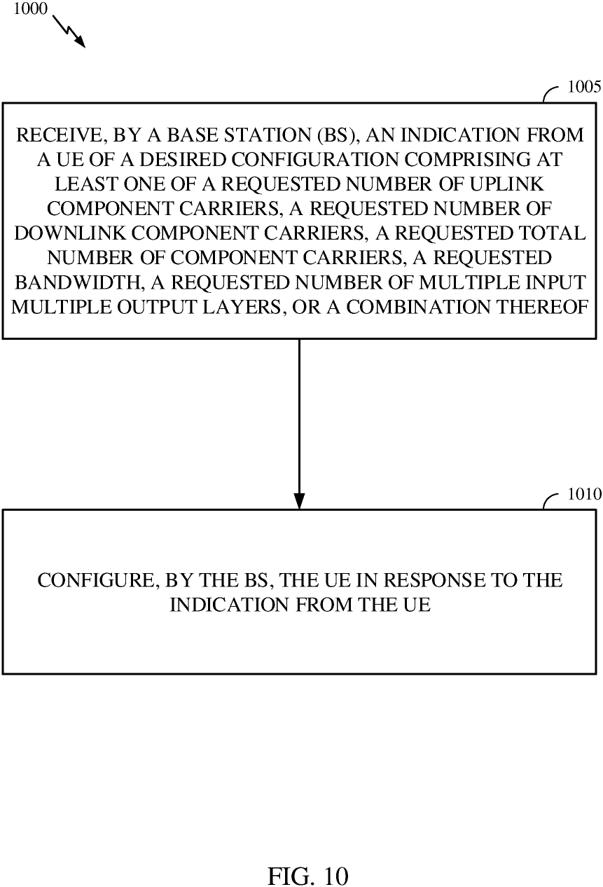

FIG. 10 is a flow diagram illustrating example operations 1000 for wireless communication, in accordance with certain aspects of the present disclosure. The operations 1000 may be performed, for example, by a BS (e.g., such as the BS 110a in the wireless communication network 100). Operations 1000 may be implemented as software components that are executed and run on one or more processors (e.g., controller/processor 240 of FIG. 2). Further, the transmission and reception of signals by the BS in operations 1000 may be enabled, for example, by one or more antennas (e.g., antennas 234 of FIG. 2). In certain aspects, the transmission and/or reception of signals by the BS may be implemented via a bus interface of one or more processors (e.g., controller/processor 240) obtaining and/or outputting signals.

The operations 1000 may begin, at 1005, by a BS receiving an indication from a UE of a desired configuration comprising at least one of a requested number of uplink component carriers, a requested number of downlink component carriers, a requested total number of component carriers, a requested bandwidth, a requested number of MIMO layers, or a combination thereof. For example, the indication may be signaled via OA signaling, such as while the UE is not associated with a thermal condition. At 1010, the BS may configure the UE in response to the indication from the UE. For example, the BS may configure the UE with the requested number of uplink component carriers, the requested number of downlink component carriers, the requested total number of component carriers, the requested bandwidth, the requested number of MIMO layers, or a combination thereof. By repurposing the OA signaling, the BS and the UE reduce overhead relative to dedicated signaling for these purposes.

According to certain aspects of the present disclosure, a UE may receive or determine multiple temperature monitoring result(s), such as multiple temperature indications, that may be made available at different times from different modules connected to the UE. Examples of such temperature monitoring results include a Wi-Fi modem measurement, a cellular modem measurement, a surface measurement, and a body measurement. The multiple thermal indications may be received or obtained before a prohibit timer of the UE expires (e.g., before the UE can send another OA request). The multiple different monitoring results may be associated with different actions to be taken. For example, the different results may indicate different reductions to be requested by the UE.

According to certain aspects, the UE may queue any thermal indications subsequent to the first thermal indication (e.g., the first thermal indication received within the prohibit timer duration). The UE may handle each thermal indication separately. For example, the UE may send OA signaling for each of the indications upon prohibit timer expiration.

According to certain other aspects, the UE may use a separate timer (e.g., a T_combine timer) to collect thermal indications. The timer (e.g., T_combine) may be the same duration as the prohibit timer or a different duration than the prohibit timer. After the expiry of the timer, the UE may combine all of the received thermal indications and determine a single reduced configuration, such as a most conservative (e.g., worst-case) reduced configuration, and send one thermal mitigation request to a BS with the reduced configuration.

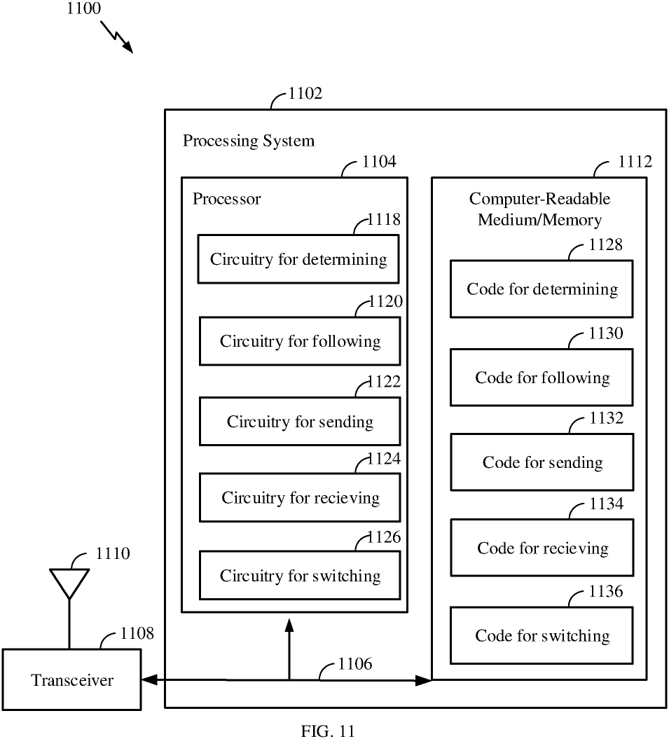

FIG. 11 illustrates a communications device 1100 that may include various components (e.g., corresponding to means-plus-function components) configured to perform operations for the techniques disclosed herein, such as the operations illustrated in FIGS. 4, 6, and 9. The communications device 1100 includes a processing system 1102 coupled to a transceiver 1108 (e.g., a transmitter and/or a receiver). The transceiver 1108 is configured to transmit and receive signals for the communications device 1100 via an antenna 1110, such as the various signals as described herein. The processing system 1102 may be configured to perform processing functions for the communications device 1100, including processing signals received and/or to be transmitted by the communications device 1100.

The processing system 1102 includes a processor 1104 coupled to a computer-readable medium/memory 1112 via a bus 1106. In certain aspects, the computer-readable medium/memory 1112 is configured to store instructions (e.g., computer-executable code) that when executed by the processor 1104, cause the processor 1104 to perform the operations illustrated in FIGS. 4, 6, and 9, or other operations for performing the various techniques discussed herein for enhanced thermal mitigation and overheating signaling. In certain aspects, computer-readable medium/memory 1112 stores code 1128 for determining; code 1130 for following; code 1132 for sending; code 1134 for receiving; and code 1136 for switching. In certain aspects, the processor 1104 has circuitry configured to implement the code stored in the computer-readable medium/memory 1112. The processor 1104 includes circuitry 1118 for determining; circuitry 1120 for following; circuitry 1122 for sending; circuitry 1124 for receiving; and circuitry 1126 for switching.

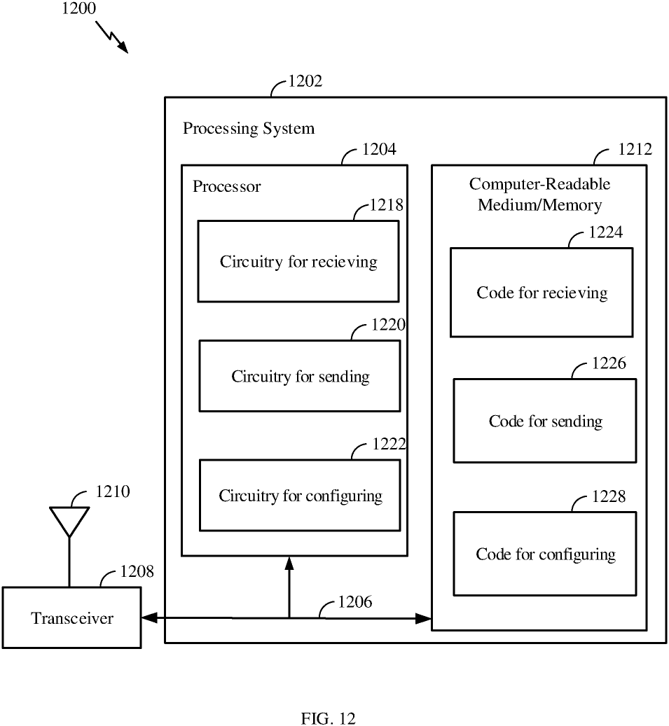

FIG. 12 illustrates a communications device 1200 that may include various components (e.g., corresponding to means-plus-function components) configured to perform operations for the techniques disclosed herein, such as the operations illustrated in FIGS. 7 and 10. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIGS. 7, and 10, or other operations for performing the various techniques discussed herein for enhanced thermal mitigation and overheating signaling. In certain aspects, computer-readable medium/memory 1212 stores code 1224 for receiving; code 1226 for sending; and, code 1228 for configuring. In certain aspects, the processor 1204 has circuitry configured to implement the code stored in the computer-readable medium/memory 1212. The processor 1204 includes circuitry 1218 for receiving; circuitry 1220 for sending; and, circuitry 1222 for configuring.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 4-10.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

The following provides an overview of some Aspects of the present disclosure:

Aspect 1: A method for wireless communication by a user equipment (UE), comprising: determining whether one or more trigger conditions of a set of one or more trigger conditions are met; and following an overheating assistance (OA) configuration received from a network or switching to an internal thermal mitigation configuration based at least in part on the determining.

Aspect 2: The method of Aspect 1, wherein the OA configuration indicates one or more OA parameters, comprising: a number of uplink component carriers (CCs); a number of downlink CCs; a maximum bandwidth; a maximum number of multiple-input multiple-output (MIMO) layers; or a combination thereof.

Aspect 3: The method of any of Aspects 1-2, wherein following the OA configuration received from the network or switching to the internal thermal mitigation configuration based at least in part on the determining comprises: following the OA configuration when none of the one or more trigger conditions is met; or switching to the internal thermal mitigation configuration when the one or more trigger conditions are met.

Aspect 4: The method of any of Aspects 1-3, wherein the one or more trigger conditions are based at least in part on at least one of: the network not supporting OA signaling; the UE not receiving the OA configuration from the network within a threshold duration; the UE receiving the OA configuration from the network, wherein the OA configuration does not include one or more OA parameters requested by the UE, includes an insufficient value for at least one of the one or more OA parameters requested by the UE, or both; the UE being configured with a prohibit timer value larger than a threshold timer value, wherein the prohibit timer indicates a time from sending an OA request to the network until another OA request can be sent to the network; and the UE determining that a thermal threshold is satisfied, or a combination thereof.

Aspect 5: The method of Aspect 4, further comprising determining whether the network supports OA signaling based at least in part on whether the network configured the UE for sending an OA request indicating a set of one or more requested OA parameters.

Aspect 6: The method of Aspect 4, further comprising: sending an OA request to the network indicating a set of one or more requested OA parameters; starting a timer based at least in part on sending the OA request; and determining whether the UE receives the OA configuration from the network before expiry of the timer, wherein the timer is associated with the threshold duration.

Aspect 7: The method of Aspect 6, where the determining is based at least in part on multiple previously received OA parameters, de-configuration commands, or de-activation commands from the network.

Aspect 8: The method of Aspect 6, wherein the determining is performed upon expiry of the timer, upon receiving a first de-configuration command from the network, or upon receiving a first de-activation command from the network.

Aspect 9: The method of Aspect 4, further comprising: sending an OA request to the network indicating the one or more OA parameters requested by the UE; receiving the OA configuration from the network; and determining whether the OA configuration includes the one or more OA parameters requested by the UE.

Aspect 10: The method of Aspect 4, further comprising determining the threshold timer value based at least in part on a UE overheating tolerance capability.

Aspect 11: The method of Aspect 4, wherein the thermal threshold comprises a maximum thermal threshold.

Aspect 12: The method of any of Aspects 1-11, wherein following the internal thermal mitigation configuration comprises following the internal thermal mitigation configuration until overheating is alleviated, wherein the internal thermal mitigation configuration is associated with an internal thermal mitigation algorithm.

Aspect 13: The method of any of Aspects 1-12, wherein following the internal thermal mitigation configuration comprises following the internal thermal mitigation configuration until after a threshold number of iterations of an internal thermal mitigation algorithm associated with the internal thermal mitigation configuration.

Aspect 14: The method of any of Aspects 1-13, wherein following the internal thermal mitigation configuration comprises following the internal thermal mitigation configuration until a temperature of the UE is below a threshold temperature, wherein the internal thermal mitigation configuration is associated with an internal thermal mitigation algorithm.

Aspect 15: The method of any of Aspects 1-14, wherein following the internal thermal mitigation configuration comprises following the internal thermal mitigation configuration until an OA configuration is received from the network that indicates a mobility change, that the network supports OA signaling, that configures a prohibit timer value within a threshold timer value, or a combination thereof, wherein the internal thermal mitigation configuration is associated with an internal thermal mitigation algorithm.

Aspect 16: The method of any of Aspects 1-15, further comprising: sending an OA request to the network indicating a set of one or more requested OA parameters associated with a UE preferred order of reduction, wherein the OA configuration indicates one or more configured OA parameters; and wherein switching to the internal thermal mitigation configuration is based at least in part on the OA configuration being different than the UE preferred order of reduction. wherein switching to the internal thermal mitigation configuration is based at least in part on the OA configuration being different than the UE preferred order of reduction.

Aspect 17: The method of Aspect 16, wherein the OA configuration indicates one or more first CCs to be reduced, and wherein the internal thermal mitigation configuration reduces one or more second CCs different than the one or more first CCs indicated by the network, wherein the one or more first CCs and the one or more second CCs include the same number of CCs.

Aspect 18: The method of any of Aspects 1-17, further comprising sending the network an indication of a UE preferred order of reduction indicating an order of preference for cell groups, component carriers (CCs), or both to be reduced.

Aspect 19: The method of Aspect 18, wherein the indication of the UE preferred order of reduction indicates weights associated with the UE preferred order of reduction.

Aspect 20: The method of Aspect 18, wherein the indication of the UE preferred order of reduction is provided via a bitmask indicating the cell groups, CCs, or both to be reduced.

Aspect 21: The method of Aspect 18, wherein the indication of the UE preferred order of reduction is provided via an out of range value of a parameter.

Aspect 22: The method of Aspect 21, wherein the out of range value of the parameter comprises a value of 0 for a channel quality indicator (CQI) associated with the cell groups, CCs, or both to be reduced.

Aspect 23: The method of Aspect 18, wherein the indication of the UE preferred order of reduction is provided before an OA request.

Aspect 24: The method of Aspect 18, wherein the indication of the UE preferred order of reduction is provided after an OA request.

Aspect 25: The method of Aspect 18, further comprising determining to use both a bitmask and an out of range value of a parameter to indicate the preferred order of reduction.

Aspect 26: The method of Aspect 18, further comprising determining whether to use a bitmask or an out of range value of a parameter to indicate the preferred order of reduction.

Aspect 27: The method of Aspect 26, wherein the determination of whether to use a bitmask or an out of range value of a parameter is based at least in part on whether a CQI report is configured on one or more CCs to be removed.

Aspect 28: The method of Aspect 27, wherein the determination is further based at least in part on whether the CQI report is periodic or aperiodic.

Aspect 29: The method of any of Aspects 1-28, further comprising: sending an indication to the network that overheating is alleviated and including one or more requested parameters.

Aspect 30: The method of Aspect 29, wherein the one or more requested parameters comprise at least one of: a requested number of uplink component carriers, a requested number of downlink component carriers, a requested total number of component carriers, a request bandwidth, a requested number of multiple input multiple output (MIMO) layers, or a combination thereof.

Aspect 31: The method of Aspect 29, wherein the indication is sent via signaling used for indicating overheating.

Aspect 32: The method of Aspect 31, wherein the signaling is sent in response to determining an overheating condition is alleviated, or is repurposed OA signaling sent in response to determining a change in one or more parameters is desired.

Aspect 33: The method of Aspect 32, further comprising: determining the change in one or more parameters is desired based at least in part on at least one of: a coverage level being below a threshold, degraded secondary cell (SCell) quality, drifted SCell timing, an incorrect cyclic prefix format, an interference condition associated with one or more SCells, a persistent lack of resources, or a combination thereof.

Aspect 34: The method of any of Aspects 1-33, further comprising: receiving multiple thermal indications from multiple thermal monitors; queuing the multiple thermal indications; and sending OA signaling for each thermal indication separately.

Aspect 35: The method of any of Aspects 1-34, further comprising: starting a combination timer; receiving multiple thermal indications from multiple thermal monitors while the combination timer is running; combining the multiple thermal indications; and sending OA signaling for the combined thermal indications.

Aspect 36: A method for wireless communications by a user equipment (UE), comprising: sending an overheating assistance (OA) request to a network indicating a set of one or more requested OA parameters; receiving, from the network, an OA configuration of one or more OA parameters; and switching to an internal UE configuration when the OA configuration is different than a UE preferred order of reduction.

Aspect 37: The method of Aspect 36, wherein the OA configuration from the network indicates CCs to be reduced, and wherein the internal UE configuration reduces different CCs that the CCs indicated by the network and corresponding to the same number of reduced CCs.

Aspect 38: A method for wireless communications by a user equipment (UE), comprising: determining a desired configuration comprising at least one of a requested number of uplink component carriers, a requested number of downlink component carriers, a requested total number of component carriers, a request bandwidth, a requested number of multiple input multiple output (MIMO) layers, or a combination thereof; and signaling the desired configuration to a network via repurposed overheating assistance (OA) signaling during a duration when the UE is not experiencing an overheating condition.

Aspect 39: The method of Aspect 38, wherein signaling the desired configuration is based at least in part on a determination of at least one of: a coverage level being below a threshold, a secondary cell (SCell) quality being below a threshold, SCell timing being drifted beyond a threshold, a configured cyclic prefix format being incorrect, an interference condition associated with one or more SCells, a persistent lack of resources, or a combination thereof.

Aspect 40: The method of Aspect 38, wherein the signaling is sent upon alleviation of an overheating condition, the UE has never experienced an overheating condition, or the UE has not experienced an overheating condition for a duration.

Aspect 41: An apparatus for wireless communication at a device, comprising a processor; memory coupled with the processor; and instructions stored in the memory and executable by the processor to cause the apparatus to perform the method of one or more of Aspects 1-40.

Aspect 42: A device for wireless communication, comprising a memory and one or more processors coupled to the memory, the one or more processors configured to perform the method of one or more of Aspects 1-40.

Aspect 43: An apparatus for wireless communication, comprising at least one means for performing the method of one or more of Aspects 1-40.

Aspect 44: A non-transitory computer-readable medium storing code for wireless communication, the code comprising instructions executable by a processor to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

1. A method for wireless communication by a user equipment (UE), comprising:
determining whether one or more trigger conditions are met; and
following an overheating assistance (OA) configuration received from a network or switching to an internal thermal mitigation configuration based at least in part on the determining.

2. The method of claim 1, wherein the OA configuration indicates one or more OA parameters, comprising:
a number of uplink component carriers (CCs);
a number of downlink CCs;
a maximum bandwidth;
a maximum number of multiple-input multiple-output (MIMO) layers; or
a combination thereof.

3. The method of claim 1, wherein following the OA configuration received from the network or switching to the internal thermal mitigation configuration based at least in part on the determining comprises:
following the OA configuration when none of the one or more trigger conditions is met; or
switching to the internal thermal mitigation configuration when the one or more trigger conditions are met.

4. The method of claim 1, wherein the one or more trigger conditions are based at least in part on at least one of:
the network not supporting OA signaling;
the UE not receiving the OA configuration from the network within a threshold duration;
the UE receiving the OA configuration from the network, wherein the OA configuration does not include one or more OA parameters requested by the UE, includes an insufficient value for at least one of the one or more OA parameters requested by the UE, or both;
the UE being configured with a prohibit timer value larger than a threshold timer value, wherein the prohibit timer value indicates a time from sending an OA request to the network until another OA request can be sent to the network; and
the UE determining that a thermal threshold is satisfied, or
a combination thereof.

5. The method of claim 4, further comprising determining whether the network supports OA signaling based at least in part on whether the network configured the UE for sending an OA request indicating a set of one or more requested OA parameters.

6. The method of claim 4, further comprising:
sending an OA request to the network indicating a set of one or more requested OA parameters;
starting a timer based at least in part on sending the OA request; and
determining whether the UE receives the OA configuration from the network before expiry of the timer, wherein the timer is associated with the threshold duration.

7. The method of claim 6, where the determining is based at least in part on multiple previously received OA parameters, de-configuration commands, or de-activation commands from the network.

8. The method of claim 6, wherein the determining is performed upon expiry of the timer, upon receiving a first de-configuration command from the network, or upon receiving a first de-activation command from the network.

9. The method of claim 4, further comprising:
sending an OA request to the network indicating the one or more OA parameters requested by the UE;
receiving the OA configuration from the network; and
determining whether the OA configuration includes the one or more OA parameters requested by the UE.

10. The method of claim 4, further comprising determining the threshold timer value based at least in part on a UE overheating tolerance capability.

11. (canceled)

12. The method of claim 1, wherein following the internal thermal mitigation configuration comprises following the internal thermal mitigation configuration until overheating is alleviated, wherein the internal thermal mitigation configuration is associated with an internal thermal mitigation algorithm.

13. The method of claim 1, wherein following the internal thermal mitigation configuration comprises following the internal thermal mitigation configuration until after a threshold number of iterations of an internal thermal mitigation algorithm associated with the internal thermal mitigation configuration.

14. The method of claim 1, wherein following the internal thermal mitigation configuration comprises following the internal thermal mitigation configuration until a temperature of the UE is below a threshold temperature, wherein the internal thermal mitigation configuration is associated with an internal thermal mitigation algorithm.

15. The method of claim 1, wherein following the internal thermal mitigation configuration comprises following the internal thermal mitigation configuration until an OA configuration is received from the network that indicates:
a mobility change,
that the network supports OA signaling,
that configures a prohibit timer value within a threshold timer value, or
a combination thereof,
wherein the internal thermal mitigation configuration is associated with an internal thermal mitigation algorithm.

16. The method of claim 1, further comprising:
sending an OA request to the network indicating a set of one or more requested OA parameters associated with a UE preferred order of reduction, wherein the OA configuration indicates one or more configured OA parameters; and
wherein switching to the internal thermal mitigation configuration is based at least in part on the OA configuration being different than the UE preferred order of reduction.

17. The method of claim 16, wherein the OA configuration indicates one or more first CCs to be reduced, and wherein the internal thermal mitigation configuration reduces one or more second CCs different than the one or more first CCs indicated by the network, wherein the one or more first CCs and the one or more second CCs include the same number of CCs.

18. The method of claim 1, further comprising sending the network an indication of a UE preferred order of reduction indicating an order of preference for cell groups, component carriers (CCs), or both to be reduced.

19. The method of claim 18, wherein the indication of the UE preferred order of reduction indicates weights associated with the UE preferred order of reduction.

20. The method of claim 18, wherein the indication of the UE preferred order of reduction is provided via a bitmask indicating the cell groups, CCs, or both to be reduced.

21. The method of claim 18, wherein the indication of the UE preferred order of reduction is provided via an out of range value of a parameter.

22. The method of claim 21, wherein the out of range value of the parameter comprises a value of 0 for a channel quality indicator (CQI) associated with the cell groups, CCs, or both to be reduced.

23-25. (canceled)

26. The method of claim 18, further comprising determining whether to use a bitmask or an out of range value of a parameter to indicate the preferred order of reduction.

27. The method of claim 26, wherein the determination of whether to use a bitmask or an out of range value of a parameter is based at least in part on whether a CQI report is configured on one or more CCs to be removed.

28. (canceled)

29. The method of claim 1, further comprising:
sending an indication to the network that overheating is alleviated and including one or more requested parameters.

30. The method of claim 29, wherein the one or more requested parameters comprise at least one of: a requested number of uplink component carriers, a requested number of downlink component carriers, a requested total number of component carriers, a request bandwidth, a requested number of multiple input multiple output (MIMO) layers, or a combination thereof.

31. The method of claim 29, wherein the indication is sent via signaling used for indicating overheating.

32. The method of claim 31, wherein the signaling is sent in response to determining an overheating condition is alleviated, or is repurposed OA signaling sent in response to determining a change in one or more parameters is desired.

33. (canceled)

34. The method of claim 1, further comprising:
receiving multiple thermal indications from multiple thermal monitors;
queuing the multiple thermal indications; and
sending OA signaling for each thermal indication separately.

35. The method of claim 1, further comprising:
starting a combination timer;
receiving multiple thermal indications from multiple thermal monitors while the combination timer is running;
combining the multiple thermal indications; and
sending OA signaling for the combined thermal indications.

36. A method for wireless communications by a user equipment (UE), comprising:
sending an overheating assistance (OA) request to a network indicating a set of one or more requested OA parameters;
receiving, from the network, an OA configuration of one or more OA parameters; and
switching to an internal UE configuration when the OA configuration is different than a UE preferred order of reduction.

37. The method of claim 36, wherein the OA configuration from the network indicates CCs to be reduced, and wherein the internal UE configuration reduces different CCs that the CCs indicated by the network and corresponding to a same number of reduced CCs.

38. A method for wireless communications by a user equipment (UE), comprising:
determining a desired configuration comprising at least one of a requested number of uplink component carriers, a requested number of downlink component carriers, a requested total number of component carriers, a request bandwidth, a requested number of multiple input multiple output (MIMO) layers, or a combination thereof; and
signaling the desired configuration to a network via repurposed overheating assistance (OA) signaling during a duration when the UE is not experiencing an overheating condition.

39. The method of claim 38, wherein signaling the desired configuration is based at least in part on a determination of at least one of:
a coverage level being below a threshold,
a secondary cell (SCell) quality being below a threshold,
SCell timing being drifted beyond a threshold,
a configured cyclic prefix format being incorrect,
an interference condition associated with one or more SCells,
a persistent lack of resources, or
a combination thereof.

40. (canceled)

41. An apparatus for wireless communication, comprising:
a memory; and
one or more processors coupled to the memory, the one or more processors and the memory being configured to:
determine whether one or more trigger conditions are met; and
follow an overheating assistance (OA) configuration received from a network or switch to an internal thermal mitigation configuration based at least in part on the determining.

42. An apparatus for wireless communication, comprising:
a memory; and
one or more processors coupled to the memory, the one or more processors configured to:
send an overheating assistance (OA) request to a network indicating a set of one or more requested OA parameters;
receive, from the network, an OA configuration of one or more OA parameters; and
switch to an internal thermal mitigation configuration when the OA configuration is different than a UE preferred order of reduction.

43-45. (canceled)
